(19) United States
(12) Patent Application Publication
(10) Pub. No.: US 2007/0169637 A1
(43) Pub. Date: Jul. 26, 2007

(54) Apparatus for sealing pressure container

(76) Inventor: Dong Woo Lee, Busan (KR)

Correspondence Address: John W Renner;Renner Otto Boisselle & Sklar, 1621 Euclid Avenue, Nineteenth Floor, Cleveland, OH, 44115, US

(21) Appl. No.: 10/587,888

(22) PCT Filed: Jan. 31, 2005
(86) PCT No.: PCT/KR05/00272

§ 371 Date: Jul. 27, 2006

(30) Foreign Application Priority Data
Feb. 5, 2004 (KR) 20-2004-0002728

(51) Int. Cl. A47J 27/08

(52) U.S. Cl. 99/337

(57) ABSTRACT

The present invention relates to an apparatus for sealing a pressure container that is characterized in that a handle body is positioned at the top of a lid and has a safety valve and a pressure automatic adjusting valve at left and right sides, and in an on and off push button installed at an upper center of the handle body, a plate operation gear having an operation gear spring is engaged to a fixture at a lower side of the push button that fixes the pinion gear and a latchet using a fixing screw, and a reverse rotation prevention pole and a pole spring are fixed at the push button using a fixing screw.

### TECHNICAL FIELD

The present invention relates to an apparatus for fully sealing a pressure container.

### BACKGROUND ART

In a conventional pressure container, an engaging protrusion formed at a lid is inserted into an engaging groove formed at an outer surface of a container when engaging a lid to the pressure container, and the lid is rotated in a certain direction, holding two handles formed at left and right sides of the lid, so that the engaging protrusion is sealingly engaged to the engaging groove of the lid. The above-described conventional pressure container has many problems when engaging or disengaging the lid. The handle type pressure container may overcome the above problems, but an engaging button and a disengaging button are separately installed at the upper and lower sides of the handle, so that the construction is so complicated. When moving the conventional pressure container, it should be moved holding the upper and lower buttons, so that the lid may be disengaged by the gap from the button for thereby causing a certain safety accident.

### DISCLOSURE OF INVENTION

Accordingly, it is an object of the present invention to overcome the above-described problems.

To achieve the above object, there is provided an apparatus for sealing a pressure container that is characterized in that a handle body is positioned at the top of a lid and has a safety valve and a pressure automatic adjusting valve at left and right sides, and in an on and off push button installed at an upper center of the handle body, a plate operation gear having an operation gear spring is engaged to a fixture at a lower side of the push button that fixes the pinion gear and a latchet using a fixing screw, and a reverse rotation prevention pole and a pole spring are fixed at the push button using a fixing screw.

### BRIEF DESCRIPTION OF DRAWINGS

The preferred embodiments of the present invention will be described with reference to the accompanying drawings.

FIG. 1 is a perspective view illustrating an apparatus for sealing a pressure container according to an embodiment of the present invention;

FIG. 2 is a cross sectional view taken along the line A-A of FIG. 1;

FIG. 3 is a disassembled perspective view of the portion B of FIG. 1;

FIG. 4 is a disassembled perspective view of the portion C of FIG. 1;

FIG. 5 is a disassembled perspective view of the portion D of FIG. 1;

FIG. 6 is a view illustrating an operation of the portion E of FIG. 3 2; and

FIG. 7 is a view of another embodiment of the construction of FIG. 2.

### BEST MODE FOR CARRYING OUT THE INVENTION

The present invention will be described with reference to the accompanying drawings.

There is provided an apparatus for sealing a pressure container in which clips 11 are formed at left and right sides of a pressure container for opening and closing a lid 12. As shown in FIG. 1, an on and off push button 2 is installed at an upper center portion of a handle body 1 installed at the top of a lid 12. The lid 12 is engaged or disengaged from the container by moving the positions of the clip 11 based on an opening and closing operation. The construction of the on and off push button 2 will be described. A plate operation gear 2e having an operation gear spring 2f is engaged with a fixture 2a adapted to fix a pinion gear 2c and a racket 2b using a fixing screw 2i and is connected with the push button 2. A pole 2h is fixed to the push button 2 using a fixing screw 2i wherein the pole has a function for preventing a reverse rotation by inserting a pole spring 2g into a lateral side of the same. A safety valve 3 formed at a through part 1b of one side of the handle body 1 is adapted to discharge an internal pressure to the outside when a pressure automatic adjusting valve 2i has an error (FIG. 4). A safety valve upper pin 3a is inserted into a vacuum lever 4 capable of maintaining a certain vacuum state in the interior of the container and is engaged with a silicon sealant 3c having a spring 3b. The safety valve upper pin 3a is engaged with a safety valve lower lever 4 having a silicon packing 3d. As shown in FIG. 5, a rotary type pressure automatic adjusting valve 6 is formed at a through part 1c of the other side of the handle body 1 for automatically adjusting an internal pressure. A steam guide 6b is fixed to a safety pin guide 6d using a fixing screw 6a.

The safety pin guide 6d having a safety pin 6c as a certain safety device for preventing a certain accident that may happen when the clip 1 is not closed includes a pressure adjusting spring 6e and a silicon sealant 6f engaged to a guide cover 6k. The safety pin guide 6d is inserted into a steam shaft 6g and a steam shaft cap 6i having a silicon packing 6h and then is engaged to the push button guide 6j.

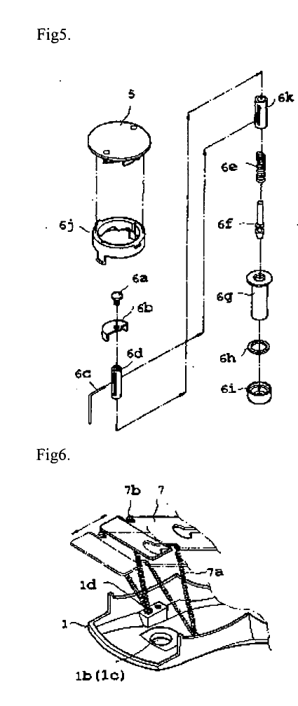

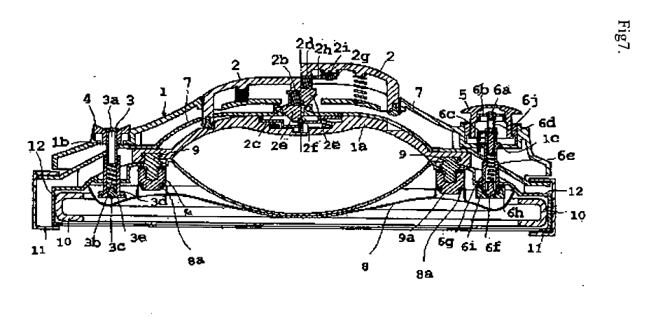

The rotary type push button 5 is engaged to a surrounding portion of a button insertion part of the handle body 1 into which the rotary type push button 5 is inserted, and is connected with the pressure automatic adjusting valve 6, wherein “0 (pressure release)”, “1 (low pressure)” and “2 (high pressure)” are indicated on the rotary type push button 5. As shown in FIG. 6, the clip 11 is connected with both lateral ends of the handle body 1, and a plate 7 is connected with the clip 11 wherein the plate 7 is operated by a plate operation spring 7a. As shown in FIG. 7, in another embodiment of the present invention, an inner cover 8 is installed at a lower side of the lid 12 for preventing a discharge of contents stored in the interior of the container.

The inner cover 8 has a silicon cover 8a, so that the contents of the pressure container is not directly contacted with the safety valve 3 and the pressure automatic adjusting valve 6. Therefore, error is prevented, and clean state is achieved, and durability is enhanced.

The preferred embodiments of the apparatus for fully sealing the pressure container according to the present invention will be described.

The operation for disengaging the lid 12 from the pressure container will be described. The pinion gear 2c engaged with the on and off push button 2 is fully engaged with the plate operation gear 2e. In a state that the plate operation gear 2e is positioned horizontally with respect to the handle body1, when the on and off push button 2 is softly pushed using one hand, the plate 7 connected with the clip 11 is pushed, and the clip 11 is widened in both directions, so that the lid 12 is easily disengaged. In the above state, when the push button 2 is released, the operation gear 2e becomes a stopped state. At this time, the pinion gear 2c fixed with the push button 2 is rotated and escaped. When engaging with the container, the lid is placed on the container, and the on and off push button 2 is pressed. The pinion gear 2c is moved down, and the plate operation gear 2e is rotated in the vertical direction with respect to the handle body 1 for thereby achieving engaged state.

The plate 7 connected with the pushed clip 11 is closed by an elastic force of the spring 2f. At this time, since the pinion gear 2c is not rotated in the reverse direction of the pinion gear 2c by the latchet 2b connected with the pinion gear 2c and the reverse rotation prevention pole 2h, so that the plate operation gear 2e is rotated.

When the on and off push button 2 is released, the pinion gear 2c is moved in the engaged state with the plate operation gear 2e and is rotated in the horizontal direction with respect to the handle body 1 by a [symbol] shaped guide (not shown) attached at both sides of the center groove of the on and off push button engaging portion of the handle body 1 and a [symbol] shaped inclination part and is position so that the lid 12 is opened for thereby repeatedly opening and closing the lid 12.

When heating the sealed pressure container, the vapor is generated, and the pressure is increased. At this time, the safety valve 3 is moved up by the internal pressure, and the insertion part hole of the safety valve 3 is blocked by the silicon packing 3d attached to the safety valve 6, and the inner portion is sealed. A certain pressure level is maintained by the pressure automatic adjusting vale 6 for thereby cooking the contents. After the cooking is finished, the heating is stopped, and the rotary type push button 5 of the upper side of the pressure automatic adjusting valve 6 is positioned at 0 (pressure release) or when the pressure container is fully cooled, the internal pressure is released, and the safety valve 3 is moved down for thereby opening the hole, so that the inner side is opened.

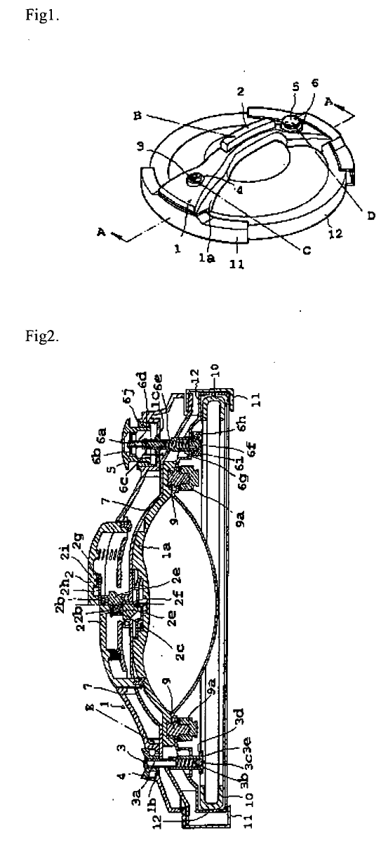

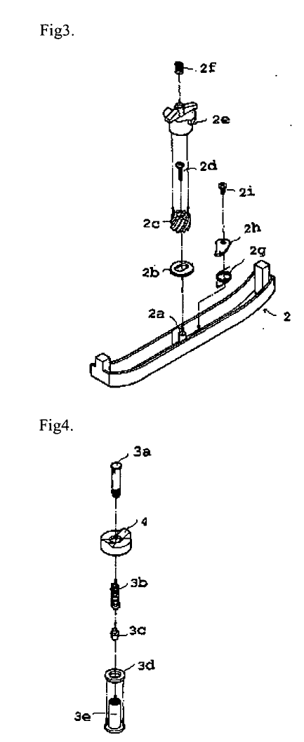

Therefore, after the cooking is finished, when the rotary type push button 5 of the upper side of the pressure automatic adjusting valve 6 is positioned at the position 1 or 2, and the vacuum lever 4 is rotated, the vacuum lever 4 is risen along the [symbol] shaped inclination portion formed at the bottom of the hole of the engaging part of the safety valve 3 of the handle body 1 and is fixed. When the safety valve 3 is fixed by the vacuum lever 4, the inner side is fully sealed. When the container is cooled, the pressure is changed to a negative pressure state, and the vacuum state is obtained for thereby storing the foods for a long time. As shown in FIG. 2, when cooking the foods, the first level (low pressure), second level (high pressure) and zero level (pressure released) of the pressure automatic adjusting valve 6 are used for adjusting the levels, so that various kinds of foods can be cooked. To achieve the above objects, the rotary type push button is adapted.

Three boss pins (not shown) are formed at every 120° at the lower side of the pressure automatic adjusting valve 6 of the handle body 1 in a [symbol] shape, and [symbol] shaped six inclination parts are formed at every 60° at the lower side of the pressure automatic adjusting valve 6, and two boss pins are protruded at the 180° direction of the inclination part, and the rotary type push button 5 is engaged with the push button guide 6j of the pressure automatic adjusting valve 6 of the handle body 1. [symbol] shaped inclination parts of different heights are formed at the inner wall. When the rotary type push button 5 is pressed, the inclination part of the pressure automatic adjusting valve 6 is rotated at 30° by three boss pins (not shown). In this state, the adjusting valve 6 is risen, two boss pins are rotated at 30° in the same direction by the guide inclination part of the adjusting valve 6, and the position of the adjusting valve 6 is determined, and the elastic force of the spring 6e is determined based on the position of the pressure automatic adjusting valve 6 for thereby adjusting the pressure. When the rotary type push button 5 is repeatedly pushed, it is rotated in the same direction, and the positions of the pressure automatic adjusting valve 6 are changed between the low, middle and high levels for thereby adjusting the pressure.

In addition, the inner cover 8 having the silicon cover 8a at left and right sides is engaged at the lower surface of the lid 12 for protecting the safety valve 3 and the pressure automatic adjusting valve 6, so that the foods stored in the container do not fill the holes of the safety valve 3 and the pressure automatic adjusting valve 6 for thereby preventing the blocking of the holes. Therefore, it is possible to enhance the safety, and it is possible to prevent the bubbles having parts of foods from being filled into the holes during the cooking operation of the pressure automatic adjusting valve 6, so that the pressure container and surrounding portions of the same are kept in a clean state.

### INDUSTRIAL APPLICABILITY

As described above, the on and off push button 2 is installed at an upper center portion of the handle body 1 formed at the upper side of the lid 12, and the pressure automatic pressure valve 6 having the safety valve 3 and the rotary type push button 5 thereon is installed at the left and right lateral sides. The inner cover 8 having the silicon cover 8a is installed at the lower surface of the lid 12. As the on and off push button 2 is softly pushed with one hand, it is possible to easily engage or disengaged the lid from the pressure container, and the vacuum lever 4 is rotated, and the safety valve 3 is risen and fixed for thereby maintaining the interior of the container in a vacuum state, so that it is possible to store the foods for a long time. In addition, the inner cover 8 attached to a lower side of the lid 12 prevents the foods from being directly contacted with the safety valve 3 and the pressure automatic adjusting valve 6. The silicon cover 8a protects the safety valve 3 and the automatic pressure adjusting valve 6 for thereby enhancing the safety, clean state and durability of the products.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An apparatus for sealing a pressure container that is characterized in that a handle body 1 is positioned at the top of a lid 12 and has a safety valve 3 and a pressure automatic adjusting valve 6 at left and right sides, and in an on and off push button 2 installed at an upper center of the handle body 1, a plate operation gear 2e having an operation gear spring 2f is engaged to a fixture 2a at a lower side of the push button 2 that fixes the pinion gear 2c and a latchet 2b using a fixing screw 2d, and a reverse rotation prevention pole 2h and a pole spring 2g are fixed at the push button 2 using a fixing screw 2i.

2. The apparatus of claim 1, wherein in the construction of a safety valve 3 for maintaining or releasing a certain vacuum state in the interior of the container and discharging the pressure when the pressure automatic adjusting valve 6 has an error, an upper pin 3a of the safety valve 3 is inserted into the vacuum lever 4 and is engaged with a silicon sealant 3c having a spring 3b and is engaged with a safety valve lower cap 3e having a silicon packing 3d therein.

3. The apparatus of claim 1, wherein in the construction of the pressure automatic adjusting valve 5 formed at the handle body 1 for automatically adjusting the inner pressure, a steam guide 6b is fixed at an upper end of the safety pin guide 6d by a fixing screw 6a wherein a safety pin 6c is inserted into the lateral side of the same, and the safety pin guide 6d having the spring 6e and the silicon sealant 6f is inserted into the steam shaft 6g, and the steam shaft 6g is inserted into a steam shaft cap 6i having the silicon packing 6h, and the steam shaft cap 6i is inserted into the push button guide 6j, and the rotary type push button 5 having the indications of 0,1 and 2 is engaged to the upper end of the push button guide 6j.

4. The apparatus of claim 1, wherein an inner cover 8 having a silicon cover 8a is engaged at the lower surface of the lid 12 for protecting the safety valve 3 and the pressure adjusting valve 6 installed at the handle body.
